(19) United States
(12) Patent Application Publication
(10) Pub. No.: US 2026/0043905 A1
(43) Pub. Date: Feb. 12, 2026

(54) MEASUREMENT APPARATUS FOR MEASURING DISTANCE TO PHYSICAL OBJECT AND/OR VELOCITY OF PHYSICAL OBJECT

(71) Applicant: Panasonic Intellectual Property Management Co., Ltd., Osaka (JP)

(72) Inventors: HIROYUKI TAKAGI, Osaka (JP); YASUHISA INADA, Osaka (JP); KENJI NARUMI, Osaka (JP); KAZUYA HISADA, Nara (JP)

(21) Appl. No.: 19/360,911

(22) Filed: Oct. 16, 2025

Related U.S. Application Data
(63) Continuation of application No. PCT/JP2023/046353, filed on Dec. 25, 2023.

(30) Foreign Application Priority Data
Apr. 25, 2023 (JP) 2023-071594

(51) Int. Cl. G01S 7/481; G01S 17/58

(52) U.S. Cl. CPC G01S 7/4814; G01S 17/58

(57) ABSTRACT

A measurement apparatus includes a light source that emits light whose frequency varies with time, a splitter that divides the light from the light source into irradiating light that is shone on a physical object and reference light, a first waveguide through which the irradiating light from the splitter and reflected light reflected from the physical object pass together, and a photodetector that detects interfering light generated by interference between the reflected light branched from the first waveguide and the reference light. The measurement apparatus satisfies f_{PD}>2D₁×Δf/(cΔt), where Δf is a change in the frequency during time Δt, c is the speed of light, D₁ is an optical path length of the first waveguide, and f_{PD} is a maximum value of a frequency that is able to be detected by the photodetector.

### BACKGROUND

### 1. Technical Field

The present disclosure relates to a measurement apparatus for measuring the distance to a physical object and/or the velocity of the physical object.

### 2. Description of the Related Art

A LIDAR (light detection and ranging) technology for measuring the distance to a physical object by irradiating the physical object with light and detecting reflected light from the physical object is under development. For example, a LiDAR apparatus that is capable of measuring the distance to a physical object and the velocity of the physical object by using an FMCW (frequency modulated continuous wave) technology is under development. Using the FMCW technology makes it possible to achieve both a wide dynamic range and high resolution for distance, makes it hard to be affected by disturbances, and makes it possible to detect not only the distance to but also the velocity of a moving physical object.

The LiDAR apparatus based on the FMCW technology includes, for example, a light source, a photodetector, and a processing circuit. The light source is controlled to emit light whose frequency changes with passage of time. The photodetector detects interfering light generated by interference between the reflected light from the physical object and reference light from the light source and thereby outputs a beat signal including a beat having a frequency corresponding to a time delay in the reflected light. The processing circuit computes the distance to the physical object and/or the velocity of the physical object on the basis of the frequency of the beat signal.

Japanese Unexamined Patent Application Publication (Translation of PCT Application) No. 2022-544743, U.S. Pat. No. 11,105,900, and Japanese Unexamined Patent Application Publication (Translation of PCT Application) No. 2019-522211 disclose examples of LiDAR apparatuses based on the FMCW technology.

### SUMMARY

One non-limiting and exemplary embodiment provides a measurement apparatus that makes it possible to expand a measurable distance range.

In one general aspect, the techniques disclosed here feature a measurement apparatus including a light source that emits light whose frequency varies with time, a splitter that divides the light from the light source into irradiating light that is shone on a physical object and reference light, a first waveguide through which the irradiating light from the splitter and reflected light reflected from the physical object pass together, and a photodetector that detects interfering light generated by interference between the reflected light branched from the first waveguide and the reference light. The measurement apparatus satisfies f_{PD}>2D₁×Δf/(cΔt), where Δf is a change in the frequency during time Δt, c is the speed of light, D₁ is an optical path length of the first waveguide, and f_{PD} is a maximum value of a frequency that is able to be detected by the photodetector.

It should be noted that general or specific embodiments of the present disclosure may be implemented as a system, an apparatus, a method, an integrated circuit, a computer program, a computer-readable storage medium such as a storage disk, or any selective combination thereof. The computer-readable storage medium includes a nonvolatile storage medium such as a CD-ROM (compact disc read-only memory). The apparatus may be constituted by one or more apparatuses. In a case where the apparatus is constituted by two or more apparatuses, the two or more apparatuses may be placed in one piece of equipment or may be separately placed in two or more separate pieces of equipment. The term “apparatus” herein or in the claims can not only mean one apparatus but also mean a system composed of a plurality of apparatuses. The plurality of apparatuses included in the “system” can include an apparatus placed in a remote location away from another apparatus and connected via a communication network.

A technology of the present disclosure makes it possible to expand a measurable distance range.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram schematically showing a configuration of a measurement apparatus according to an exemplary first embodiment of the present disclosure;

FIG. 2A is a diagram schematically showing examples of time changes in the frequencies of reference light and reflected light in a case where a physical object is at rest;

FIG. 2B is a diagram schematically showing examples of time changes in the frequencies of the reference light and the reflected light in a case where the physical object is moving;

FIG. 3 is a flow chart schematically showing an example of a measuring operation that a processing circuit executes;

FIG. 4 is a graph showing an example of the power spectra of a beat signal;

FIG. 5 is a diagram for explaining a relationship between optical path length and beat frequency and the influence of various types of noise;

FIG. 6A is a diagram for explaining examples of various types of noise in a case where d₅=d₁+2d₂+d₄;

FIG. 6B is a diagram for explaining examples of various types of noise in a case where d₅=d₁+d₂+d₄;

FIG. 6C is a diagram for explaining examples of various types of noise in a case where d₅=d₁+d₄;

FIG. 7 is a diagram for explaining the influence of optical element noise in a case where the optical path length d₂ is brought close to 0;

FIG. 8A is a first diagram for explaining changes in the frequencies of various types of noise and a target frequency in a case where various optical path lengths are adjusted;

FIG. 8B is a second diagram for explaining changes in the frequencies of various types of noise and the target frequency in a case where various optical path lengths are adjusted;

FIG. 8C is a third diagram for explaining changes in the frequencies of various types of noise and the target frequency in a case where various optical path lengths are adjusted;

FIG. 9 is a block diagram showing a configuration of a measurement apparatus according to a modification; and

FIG. 10 is a block diagram showing a configuration of a measurement apparatus according to another modification.

### DETAILED DESCRIPTIONS

In the present disclosure, all or some of the circuits, units, apparatuses, members, or sections or all or some of the functional blocks in the block diagrams can be implemented as one or more electronic circuits including a semiconductor device, a semiconductor integrated circuit (IC), or an LSI (large scale integration). The LSI or IC can be integrated into one chip, or also can be a combination of multiple chips. For example, functional blocks other than a storage element may be integrated into one chip. The name used here is LSI or IC, but it may also be called system LSI, VLSI (very large scale integration), or ULSI (ultra large scale integration) depending on the degree of integration. A field programmable gate array (FPGA) that can be programmed after manufacturing an LSI or an RLD (reconfigurable logic device) that allows reconfiguration of the connection or setup of circuit cells inside the LSI can be used for the same purpose.

Further, it is also possible that all or some of the functions or operations of the circuits, units, apparatuses, members, or sections are implemented by executing software. In such a case, the software is stored on one or more non-transitory storage media such as a ROM, an optical disk, or a hard disk drive, and when the software is executed by a processor, the software causes the processor together with peripheral devices to execute the functions specified in the software. A system or an apparatus may include such one or more non-transitory storage media on which the software is stored and a processor together with necessary hardware devices such as an interface.

The term “light” herein means not only visible light (with wavelengths of approximately 400 nm to approximately 700 nm) but also electromagnetic waves including ultraviolet radiation (with wavelengths of approximately 10 nm to approximately 400 nm) and infrared radiation (with wavelengths of approximately 700 nm to approximately 1 mm). The ultraviolet radiation is herein sometimes referred to as “ultraviolet light”, and the infrared radiation is herein sometimes referred to as “infrared light”.

A measurement apparatus according to an embodiment of the present disclosure includes a light source that emits light whose frequency varies with time, a splitter that divides the light from the light source into irradiating light that is shone on a physical object and reference light, a first waveguide through which the irradiating light from the splitter and reflected light reflected from the physical object pass together, and a photodetector that detects interfering light generated by interference between the reflected light branched from the first waveguide and the reference light. The measurement apparatus satisfies f_{PD}>2D₁×Δf/cΔt, where Δf is a change in the frequency during time Δt, c is the speed of light, D₁ is an optical path length of the first waveguide, and f_{PD} is a maximum value of a frequency that is able to be detected by the photodetector.

The foregoing configuration makes it possible to measure the distance to the physical object and/or the velocity of the physical object on the basis of a signal outputted from the photodetector.

The photodetector can be configured to output a signal corresponding to an intensity of the interfering light. The measurement apparatus may further include a processing circuit that computes a distance to the physical object and/or a velocity of the physical object on the basis of the signal outputted from the photodetector.

The processing circuit can be configured to compute the distance and/or the velocity on the basis of a frequency component of the signal outputted from the photodetector. In a case where a maximum value of a frequency that is able to be detected by the processing circuit is lower than the maximum value of the frequency that is able to be detected by the photodetector, the measurement apparatus may be configured to satisfy the foregoing inequality with f_{PD} being the maximum value of the frequency that is able to be detected by the processing.

The measurement apparatus may further include an optical element that irradiates the physical object with the irradiating light having passed through the first waveguide and that introduces the reflected light into the first waveguide. The measurement apparatus may satisfy f_{PD}>(2D₁+2Dₜ)×Δf/cΔt, where Dₜ is a measurable maximum value of a distance from the optical element to the physical object.

Satisfying this condition makes it possible to measure a physical object that is present at the longest distance imaginable.

The measurement apparatus may satisfy

$$\frac{2 {D}_{1} \times Δ f / c Δt}{{f}_{PD}} \leq 0.5$$

Satisfying this condition makes it possible that a band in which noise is generated by unwanted reflected light generated inside the first waveguide can be reduced to half or less of a band of frequencies that are able to be detected by the photodetector. This results in making it possible to widen a range of measurable distances to the physical object.

The measurement apparatus may further include a second waveguide that branches off from the first waveguide and that allows passage of the reflected light having passed through the first waveguide, a third waveguide through which the irradiating light from the splitter passes, and a dividing element that inputs, to the first waveguide, the irradiating light having passed through the third waveguide and that inputs, to the second waveguide, the reflected light having passed through the first waveguide. The measurement apparatus may satisfy 2D₁≥d_{c}, where d_{c} is an optical path length in the dividing element along which a portion of the irradiating light from the third waveguide travels through the dividing element toward the second waveguide.

Satisfying this condition makes it easy to avoid a situation where beat frequencies actually corresponding to two different distances become identical. This results in the expansion of a measurable distance range.

The measurement apparatus may further include a fourth waveguide through which the reference light from the splitter passes and a coupling element that inputs, to the photodetector, interfering light generated by interference between the reference light having passed through the fourth waveguide and the reflected light having passed through the second waveguide. The measurement apparatus may satisfy D₄≤D₃+2D₁+D₂ and |D₃+2D₁+D₂−D₄|≥|D₃+D_{c}+D₂−D₄|, where D₂ is an optical path length of the second waveguide, D₃ is an optical path length of the third waveguide, and D₄ is an optical path length of the fourth waveguide.

Satisfying this condition makes it easy to avoid a situation where beat frequencies actually corresponding to two different distances become identical, making it possible to widen a measurable distance range.

The measurement apparatus may further include an optical head that accommodates at least part of the first waveguide and at least part of a third waveguide that inputs the irradiating light from the splitter to the first waveguide.

This makes it possible to flexibly adjust the position and angle of emission of light that is shone on the physical object.

Another embodiment of the present disclosure is directed to a measurement apparatus including a LiDAR unit. The LiDAR unit includes a light source, a splitter that divides light from the light source into irradiating light and reference light, an outputter that outputs the irradiating light from the splitter, an inputter to which reflected light from a physical object irradiated with the irradiating light is inputted, and a photodetector that detects the reflected light and the reference light. The measurement apparatus further includes a first waveguide through which the irradiating light and the reflected light pass together; a second waveguide that branches off from the first waveguide and that inputs, to the inputter, the reflected light having passed through the first waveguide; and a third waveguide that inputs, to the first waveguide, the irradiating light outputted from the outputter.

This configuration makes it possible to flexibly adjust, according to the lengths of the second waveguide and the fourth waveguide, the position and angle of emission of light that is shone on the physical object.

The LiDAR unit can further include a fourth waveguide through which the reference light from the splitter passes and a coupling element that inputs, to the photodetector, interfering light generated by interference between the reference light having passed through the fourth waveguide and the reflected light having passed through the second waveguide.

The measurement apparatus may further include a chip having the light source, the splitter, the coupling element, and the photodetector integrated thereon. The outputter can be an element that couples together a waveguide on the chip connected to the splitter and the third waveguide. The inputter can be an element that couples together another waveguide on the chip connected to the coupling element and the second waveguide.

The chip may further have integrated thereon a processing circuit that computes a distance to the physical object and/or a velocity of the physical object on the basis of a signal outputted from the photodetector.

The measurement apparatus may further include a housing that accommodates the light source, the splitter, the coupling element, and the photodetector. The outputter can be an output terminal of the housing connected to the splitter. The inputter can be an input terminal of the housing connected to the coupling element.

The housing may further include a processing circuit that computes a distance to the physical object and/or a velocity of the physical object on the basis of a signal outputted from the photodetector.

The measurement apparatus may further include an optical head that accommodates at least part of the first waveguide, at least part of the second waveguide, and at least part of the third waveguide.

The following describes an exemplary embodiment of the present disclosure. It should be noted that the embodiments to be described below illustrate general or specific examples. The numerical values, shapes, constituent elements, placement and topology of constituent elements, steps, orders of steps, or other features that are shown in the following embodiments are merely examples and are not intended to limit the present disclosure. Further, those of the constituent elements in the following embodiments which are not recited in an independent claim representing the most generic concept are described as optional constituent elements. Further, the drawings are schematic views and are not necessarily strict illustrations. Furthermore, in the drawings, substantially identical components are given identical reference signs, and a repeated description may be omitted or simplified.

### EMBODIMENTS

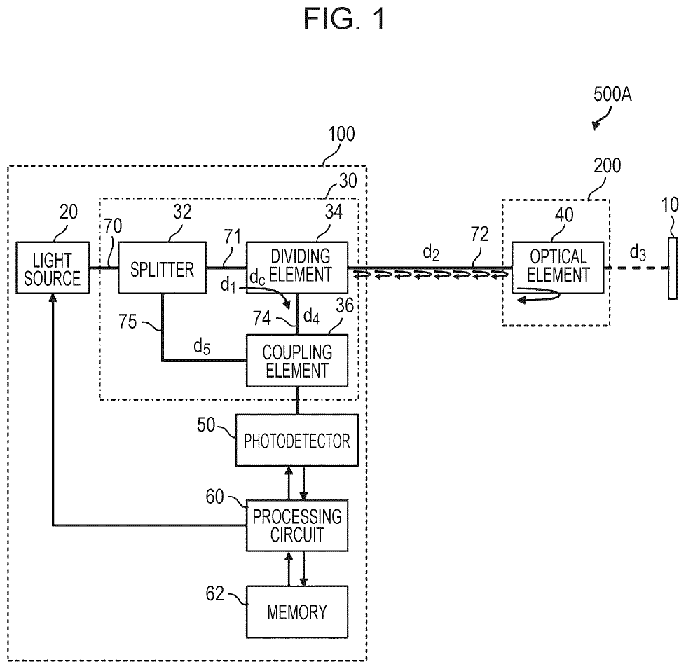

FIG. 1 is a block diagram schematically showing a configuration of a measurement apparatus 500A according to an exemplary first embodiment of the present disclosure. The measurement apparatus 500A shown in FIG. 1 includes a LiDAR unit 100 and an optical head 200. The LiDAR unit 100 includes a light source 20, an interference optical system 30, a photodetector 50, a processing circuit 60, and a memory 62. The interference optical system 30 includes a splitter 32, a dividing element 34, and a coupling element 36. The optical head 200 includes an optical element 40 such as a collimator lens. A thick line shown in FIG. 1 represents an optical waveguide, such as an optical fiber, that connects two constituent elements to each other. An optical waveguide is herein sometimes referred to simply as “waveguide”. An arrowed solid line shown in FIG. 1 represents the flow of a signal. A dashed line shown in FIG. 1 represents light shone on a physical object 10.

The light source 20 can be, for example, a laser light source that emits laser light. The laser light that is emitted from the light source 20 is hereinafter sometimes referred to as “output light”. The light source 20 is capable of varying the frequency of the output light. The frequency of the output light can be modulated with constant periodicity, for example, in the form of a triangular wave or a sawtooth wave. The periodicity of the frequency does not need to be always constant but may change with passage of time. The periodicity of the frequency can be, for example, longer than or equal to 1 microsecond (μs) and shorter than or equal to 10 milliseconds (ms). A range of fluctuation in the frequency, i.e. a difference between a minimum value and a maximum value of the frequency, can be, for example, from 100 MHz to 1 THz. The wavelength of the output light can be included in a wavelength range of near-infrared light, for example, of 700 nm to 2000 nm. Using near-infrared light as the output light makes it possible to, even in the case of a measurement performed outdoors during the daytime, reduce the influence of noise attributed to sunlight. The wavelength of the output light does not necessarily need to be included in the wavelength range of near-infrared light. The wavelength of the output light may be included in a wavelength range of visible light of 400 nm to 700 nm or may be included in a wavelength range of ultraviolet light. The light source 20 can include, for example, a distributed feedback laser diode or a laser diode with an external resonator. These laser diodes are low in price and small in size, are capable of single-mode oscillation, and can vary the frequency of the output light according to the amount of current that is applied. The intensity and frequency of the output light that is outputted from the light source 20 can be controlled by a controller such as the processing circuit 60.

The splitter 32 is connected to the light source 20 via a waveguide 70, connected to the dividing element 34 via a waveguide 71, and connected to the coupling element 36 via a waveguide 75. The splitter 32 separates the output light emitted from the light source 20 into reference light and irradiating light that is shone on the physical object 10. The splitter 32 inputs the reference light to the coupling element 36 and inputs the irradiating light to the dividing element 34.

The dividing element 34 can be, for example, an optical splitter or a circulator. The dividing element 34 is connected to the splitter 32 via the waveguide 71, connected to the coupling element 36 via a waveguide 74, and connected to the optical element 40 of the optical head 200 via a waveguide 72. The dividing element 34 inputs the irradiating light from the splitter 32 to the optical element 40 and inputs reflected light from the physical object 10 to the coupling element 36.

The coupling element 36 can be, for example, an optical splitter or an optical coupler. The coupling element 36 inputs, to the photodetector 50, interfering light generated by interference between the reference light from the splitter 32 and the reflected light from the dividing element 34.

The optical element 40 emits outward the irradiating light having passed through the waveguide 72 and introduces the reflected light from the physical object 10 into the waveguide 72. The optical element 40 can be, for example, a collimator lens that collimates the irradiating light. The term “collimate” herein means not only a case where the irradiating light is turned into parallel light but also a case where the spread of the irradiating light is reduced. The optical element 40 is not limited to the collimator lens but may be a diffraction grating that emits the irradiating light outward as zero-order diffracted light and/or ±N-order diffracted light (where N is an integer greater than or equal to 1). Measuring the distance to the physical object 10 with a plurality of rays of diffracted light emitted in different directions makes it possible to expand an angular range of measurement of the distance to the physical object 10.

The optical head 200 may include a beam scanner constituted, for example, by a MEMS (microelectromechanical system) or other components. The beam scanner makes it possible to change the direction of the irradiating light.

The photodetector 50 detects the interfering light outputted from the coupling element 36. The photodetector 50 includes one or more photodetection elements. The photodetection elements output electrical signals corresponding to the intensity of the interfering light.

In the measurement apparatus 500A, an optical path of the irradiating light from the interference optical system 30 to the physical object 10 and an optical path of the reflected light from the physical object 10 to the interference optical system 30 overlap each other. Employing such a coaxial optical system makes it possible to make the measurement apparatus 500A simple in configuration and achieve a stable measurement.

The processing circuit 60 functions as a controller that controls how the light source 20 and the photodetector 50 operate. The processing circuit 60 performs a process based on the FMCW-LiDAR technology. Specifically, the processing circuit 60 causes the light source 20 to emit light whose frequency varies with time, and causes the photodetector 50 to detect the interfering light generated by interference between the reference light and the reflected light from the physical object 10. The processing circuit 60 computes the distance to the physical object 10 and/or the velocity of the physical object 10 on the basis of a time-series signal outputted from the photodetector 50 and generates and outputs measurement data pertaining to the distance and/or the velocity.

The processing circuit 60 computes the distance and/or the velocity by executing a computer program stored in the memory 62 such as a ROM or a RAM (random-access memory). Thus, the measurement apparatus 500A includes a processor including the processing circuit 60 and the memory 62. The processing circuit 60 and the memory 62 may be integrated on one circuit board, or may be provided on separate circuit boards. Functions of control and signal processing by the processing circuit 60 may be dispersed across a plurality of circuits. The processor may be placed in a place away from other constituent elements. In that case, the processor may control, via a cable or wireless communication network, how the light source 20 and the photodetector 50 operates and process, via the communication network, a signal outputted from the photodetector 50.

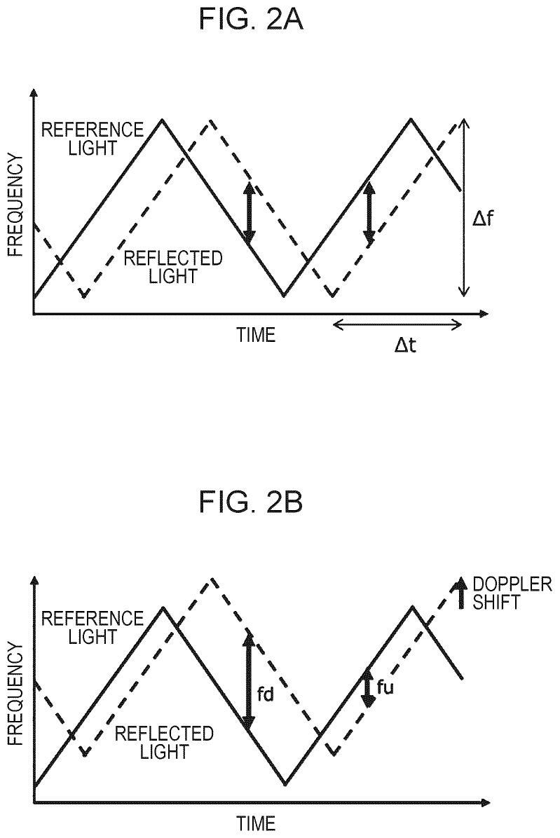

Next, a principle of distance and velocity measurement based on the FMCW-LiDAR technique is described with reference to FIGS. 2A and 2B.

FIG. 2A is a diagram schematically showing examples of time changes in the frequencies of reference light and reflected light in a case where the physical object 10 is at rest. The solid line represents the reference light, and the dashed line represents the reflected light. The frequency of the reference light shown in FIG. 2A repeats time changes in the form of a triangular wave. That is, the frequency of the reference light repeats per cycle an up chirp during which the frequency linearly increases and a down chirp during which the frequency then linearly decreases as much as it increased. The increase in the frequency in an up-chirp period and the decrease in the frequency in a down-chirp period are equal to each other. In a case where the total optical path length of the irradiating light and the reflected light is longer than the optical path length of the reference light, the frequency of the reflected light shifts in a positive direction along a time axis as compared with the frequency of the reference light. On the other hand, in a case where the total optical path length of the irradiating light and the reflected light is shorter than the optical path length of the reference light, the frequency of the reflected light shifts in a negative direction along the time axis as compared with the frequency of the reference light. The shift amount of time of the reflected light is proportional to the absolute value of the difference between the total optical path length of the irradiating light and the reflected light and the optical path length of the reference light. Accordingly, interfering light generated by interference between the reference light and the reflected light has a beat of a frequency corresponding to the absolute value of the difference between the frequency of the reflected light and the frequency of the reference light. The thick double-headed arrows shown in FIG. 2A represent the difference in frequency between the reference light and the reflected light. The photodetector 50 outputs a time-series signal indicating a change in intensity of the interfering light. Such a signal is called a beat signal. The frequency of the beat signal, i.e. a beat frequency, is equal to the absolute value of the difference in frequency between the reflected light and the interfering light. The processing circuit 60 can compute the distance to the physical object 10 on the basis of the beat frequency.

In a case where the physical object 10 is at rest, a beat frequency in an up-chirp period and a beat frequency in a down-chirp period are equal to each other. Let it be assumed here that as indicated by a thin double-headed arrow in FIG. 2A, Δf is the range of fluctuations in the frequency of light during each of the up-chirp and down-chirp periods and Δt is the time required for the frequency to change by Δf. Let it also be assumed that c is the speed of light and that Δd is the absolute value of the difference between the total of the optical path lengths of the irradiating light and the reflected light and the optical path length of the reference light. The beat frequency f_{beat} in the up-chirp period or the down-chirp period is represented by Formula (1) as follows:

$${f}_{beat} = \frac{Δ f}{c Δ t} Δ d \qquad ( 1 )$$

The beat frequency f_{beat} is obtained by multiplying the time rate of change Δf/Δt in the frequency by the time (Δd/c) required for light to propagate by the optical path length difference Δd. Let it be assumed that as shown in FIG. 1, d₁ is the optical path length of the waveguide 71, d₂ is the optical path length of the waveguide 72, d₃ is an optical path length from the optical element 40 to the physical object 10, and d₄ is the optical path length of the waveguide 74. The waveguide 71 corresponds to the aforementioned “third waveguide”, and the optical path length d₁ corresponds to the aforementioned optical path length D₃. The waveguide 72 corresponds to the aforementioned “first waveguide”, and the optical path length d₂ corresponds to the aforementioned optical path length D₁. The waveguide 74 corresponds to the aforementioned “second waveguide”, and the optical path length d₄ corresponds to the aforementioned optical path length D₂. The waveguide 75 corresponds to the aforementioned “fourth waveguide”, and the optical path length d₅ corresponds to the aforementioned optical path length D₄. The optical path length difference Δd between the reflected light reflected back off the physical object 10 and the reference light is expressed by Formula (2) as follows:

$$Δ d = \vert {d}_{1} + 2 {d}_{2} + 2 {d}_{3} + {d}_{4} - {d}_{5} \vert \qquad ( 2 )$$

The optical path lengths d₁, d₂, d₄, and d₅ are predetermined fixed values. Further, Δf, Δt, and c in Formula (1) are also known values, and f_{beat} is obtained by a frequency analysis of the beat signal. Accordingly, the processing circuit 60 can calculate the distance d₃ from the optical element 40 to the physical object 10 on the basis of Formulas (1) and (2).

FIG. 2B is a diagram schematically showing examples of time changes in the frequencies of the reference light and the reflected light in a case where the physical object 10 is moving. As shown in FIG. 2B, in a case where the physical object 10 moves nearer to the optical head 200, a Doppler shift causes the frequency of the reflected light to shift in a positive direction along a frequency axis as compared with a case where the physical object 10 is at rest. On the other hand, in a case where the physical object 10 moves away from the optical head 200, a Doppler shift causes the frequency of the reflected light to shift in a negative direction along the frequency axis as compared with a case where the physical object 10 is at rest. The shift amount of frequency of the reflected light depends on the magnitude of a component obtained by projecting the velocity vector of an irradiated portion of the physical object 10 in the direction of the reflected light. In a case where the physical object 10 moves, the beat frequency can vary between an up-chirp period and a down-chirp period. In the example shown in FIG. 2B, a beat frequency fd in a down-chirp period during which the frequencies of both the reflected light and the reference light linearly decrease is higher than a beat frequency fu in an up-chirp period during which the frequencies of both the reflected light and the reference light linearly increase. The processing circuit 60 can calculate the velocity of the physical object 10 on the basis of this difference in beat frequency (fd−fu). The processing circuit 60 may calculate the distance from the optical head 200 to the physical object 10 with the average of the beat frequency fu in an up-chirp period and the beat frequency fd in a down-chirp period being the beat frequency f_{beat} in Formula (1) above.

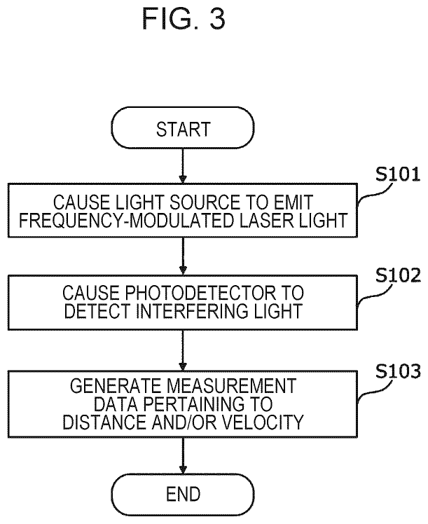

FIG. 3 is a flow chart schematically showing an example of a measuring operation that the processing circuit 60 executes. The processing circuit 60 executes the actions of steps S101 to S103 shown in FIG. 3.

In step S101, the processing circuit 60 causes the light source 20 to emit laser light whose frequency varies with time. In the examples shown in FIGS. 2A and 2B, the processing circuit 60 causes the light source 20 to emit laser light whose frequency varies in the form of a triangular wave. In the case of a use where the velocity of the physical object 10 is not measured and the distance to the physical object 10 is measured, the frequency of the laser light may be varied in the form of a sawtooth wave.

In step S102, the processing circuit 60 causes the photodetector 50 to detect interfering light generated by interference between reflected light and reference light. The photodetector 50 outputs, at predetermined intervals, a signal corresponding to the intensity of the interfering light.

In step S103, the processing circuit 60 computes the distance to and/or the velocity of the physical object 10 on the basis of the signal outputted from the photodetector 50. The processing circuit 60 may perform a process such as the fast Fourier transform (FFT) on the basis of a time-series signal outputted from the photodetector 50, obtain the intensity for each frequency component, and process, as the beat frequency, a frequency at which the intensity exceeds a threshold. The processing circuit 60 can generate data pertaining to the distance to and/or the velocity of the physical object 10 by performing the aforementioned computation on the basis of the beat frequency.

In the measurement apparatus 500A shown in FIG. 1, the LiDAR unit 100 and the optical head 200 are not accommodated in one housing but are separated from each other. The waveguide 72, which connects the LiDAR unit 100 and the optical head 200 to each other, can be achieved, for example, a comparatively long optical fiber cable. Such a configuration makes it possible to reduce the volume and weight of the optical head 200 and increase the degree of freedom of placement of the optical head 200. Even in a case where the physical object 10 has a complex shape or a large size, the position and orientation of the optical head 200 can be flexibly changed according to the shape or the size.

In general, the wavelength stability of the light source 20 is susceptible to temperature, and changes in temperature affect the accuracy of measurement of the distance and the velocity. Further, the processing circuit 60, which is a precision device, requires vibration resistance in addition to temperature resistance. For this reason, the LiDAR unit 100 can include a housing having temperature resistance and vibration resistance. In the housing, the light source 20, the interference optical system 30, the photodetector 50, the processing circuit 60, and the memory 62 can be accommodated. This makes it possible to stabilize the accuracy of measurement of the distance and the velocity. The housing may contain only some of the light source 20, the interference optical system 30, the photodetector 50, and the processing circuit 60. For example, the housing may contain the light source 20, the interference optical system 30, and the photodetector 50 and may not contain the processing circuit 60 and the memory 62. Further, some or all of the light source 20, the interference optical system 30, the photodetector 50, the processing circuit 60, the memory 62, and waveguides and wires connecting them may be integrated on one chip. Such a configuration makes it possible to improve the degree of freedom of fabrication and design of the LiDAR unit 100.

In the configuration shown in FIG. 1, a beat signal that is outputted from the photodetector 50 can contain, in addition to a frequency component attributed to reflected light from the physical object 10, a frequency component (i.e., noise) attributed to light other than the reflected light from the physical object 10. Noise can be generated because a portion of the irradiating light inputted from the splitter 32 to the dividing element 34 travels toward the coupling element 36 instead of traveling toward the optical element 40 and falls on the photodetector 50. Further, noise can be generated because a portion of the irradiating light having passed through the waveguide 72 is reflected off a lens surface instead of passing through the optical element 40. Furthermore, noise can be generated due to reflections of light that occur inside the waveguide 72, which connects the dividing element 34 and the optical element 40 to each other. In particular, as in the example shown in FIG. 1, in a case where the dividing element 34 and the optical element 40 are connected to each other by the waveguide 72 such as a comparatively long optical fiber cable, the optical path of the irradiating light varies according to the position of the optical head 200, so that reflections of light and crosstalk tend to occur in the optical path. This can result in generation of noise in a beat signal that is detected by the photodetector 50, creation of a distance range within which the distance or the velocity cannot be measured, and a narrowing of a measurable distance range.

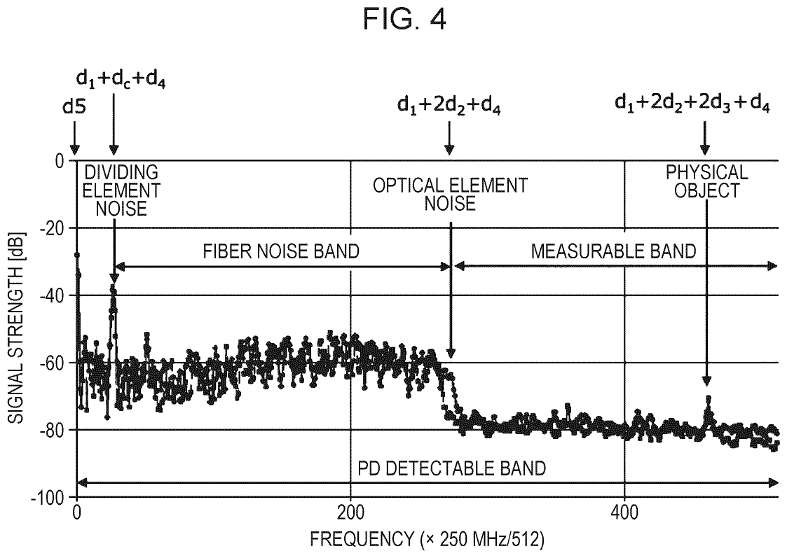

In the present embodiment, the expansion of a measurable distance range can be achieved by reducing the influence of noise by appropriately adjusting the optical path lengths d₁, d₂, d₄, and d₅ shown in FIG. 1. A relationship between the optical path lengths d₁, d₂, d₄, and d₅ and the influence of noise is explained in more detail with reference to FIG. 4.

FIG. 4 is a graph showing an example of the strength of a beat signal for each frequency component, i.e. the power spectra of the beat signal. By performing a process such as the FFT on the basis of a beat signal outputted from the photodetector 50, the processing circuit 60 can generate data on power spectra such as those shown in FIG. 4. In the graph shown in FIG. 4, the horizontal axis represents frequency, and the vertical axis represents signal strength. In the example shown in FIG. 4, the frequency is expressed by numerical values of 9 bits (from 0 to 511), and the width of each gradation represents 250 MHz/512. The frequency on the horizontal axis corresponds to the absolute value of the difference between an optical path length from the splitter 32 to the coupling element 36 and the optical path length d₅ of the reference light. When the optical path length is equal to the optical path length d₅ of the reference light, the frequency becomes zero. In FIG. 4, a spectrum in an up-chirp period and a spectrum in a down-chirp period are superimposed on each other. In a case where the physical object 10 is at rest, these spectra behave substantially in the same way.

In this example, the frequency of laser light from the light source 20 is modulated in the form of a triangular wave as shown in FIG. 2A. In a case where the physical object 10 is at rest, peaks of the beat signal appear at frequencies corresponding to the optical path length in both the up-chirp and down-chirp periods of the triangular wave. In a case where the physical object 10 has a velocity, there is a difference between frequencies of the beat signal between the up-chirp period and the down-chirp period, so that the velocity can be detected on the basis of the frequency difference.

In the configuration shown in FIG. 1, when noise light from an object other than the physical object 10 enters the photodetector 50, noise is generated in the beat signal on the basis of the aforementioned Formula (1). FIG. 4 shows optical element noise generated in the optical element 40 and dividing element noise generated in the dividing element 34.

The optical element noise can be generated by reflections at an interface between an optical fiber constituting the waveguide 72 and air and an interface between air and glass of the optical element 40 (e.g., a collimator lens). The optical element noise is generated at a frequency corresponding to the absolute value |d₁+2d₂+d₄−d₅| of the difference between the optical path length d₁+2d₂+d₄ of light exiting the splitter 32, reflected off the optical element 40, and arriving at the coupling element 36 and the optical path length d₅ of the reference light from the splitter 32 to the coupling element 36. In the example shown in FIG. 4, the optical path length d₁+2d₂+d₄ is longer than the optical path length d₅ of the reference light. In this case, the optical path length d₁+2d₂+2d₃+d₄ of light exiting the splitter 32, reflected off the physical object 10, and arriving at the coupling element 36 is greater than the optical path length d₅ of the reference light, so that the corresponding frequency becomes higher. Therefore, assuming that the frequency at which the optical element noise is generated corresponds to zero distance, a frequency that is higher than the frequency can be treated as a frequency to be measured. Accordingly, the optical element noise has only a small effect on the measurement of the distance to the physical object 10.

The dividing element noise is generated when a portion of light inputted from the splitter 32 to the dividing element 34 (e.g., a circulator) travels not toward the optical element 40, toward which the light is originally supposed to travel, but toward the coupling element 36 and enters the photodetector 50. It is experimentally confirmed that the optical path length in the dividing element 34 of noise light that generates the dividing element noise is longer than the total of the optical path lengths in the dividing element 34 of irradiating light traveling from the dividing element 34 toward the optical element 40 and reflected light generated due to reflection of the irradiating light. This difference in optical path length is hereinafter expressed as the optical path length d_{c} of the noise light in the dividing element 34. In the example shown in FIG. 4, the absolute value |d₁+d_{c}+d₄−d₅| of the difference between the optical path length d₁+d_{c}+d₄ of the noise light from the splitter 32 to the coupling element 36 and the optical path length d₅ of the reference light is small, so that the effect on the measurement of the distance to the physical object 10 is small. However, in a case where d₅ is great, the optical path length difference |d₁+d_{c}+d₄−d₅| corresponding to the dividing element noise can become greater than the optical path length difference |d₁+2d₂+d₄−d₅| corresponding to the optical element noise. In that case, the dividing element noise can be generated near the beat frequency of the physical object 10, so that it becomes impossible to distinguish between the beat frequency of the physical object 10 and the noise. As a result, it becomes impossible to measure the distance and the velocity in a band in which the dividing element noise is generated. As in the example shown in FIG. 4, the effect of the dividing element noise on the measurement can be reduced by causing the dividing element noise to be generated at a frequency that is lower than the frequency at which the optical element noise is generated.

In the example shown in FIG. 4, the noise floor is higher on the low-frequency side by approximately 20 dB than it is on the high-frequency side of a frequency of approximately 280 (×250 MHz/512) on the horizontal axis. Depending on the values of the optical path lengths d₁, d₂, d₄, and d₅, this high noise floor can also be generated in a band of frequencies for measuring the distance to or the velocity of the physical object 10. In a case where the physical object 10 has a low reflectance, a band of frequencies in which measurement becomes impossible due to the influence of the noise floor can be generated. For this reason, a band of frequencies in which measurement is possible even in the case of a low reflectance (such a band of frequencies being referred to as “measurable band”) can become narrower. In the example shown in FIG. 4, a band of frequencies that are able to be detected by the photodetector 50 (such a band of frequencies being referred to as “PD detectable band”) is 250 MHz, 50% or more of which is occupied by noise. Depending on the values of the optical path lengths d₁, d₂, d₄, and d₅, the measurable band can become even narrower.

The inventors analyzed a factor in this rise in noise floor and found that the optical path length d₂ of the waveguide 72 shown in FIG. 1 was responsible for the rise. The optical fiber constituting the waveguide 72 causes Rayleigh scattering due to particles in the optical fiber that are sufficiently smaller than wavelengths or fluctuations in density, stress, or composition. For this reason, back scattering of light throughout the optical fiber can occur. Noise light generated by back scattering inside the waveguide 72 passes through the same path as the reflected light from the physical object 10 and enters the photodetector 50. This is the cause of a noise band. This noise band, which is attributed to the optical fiber, is referred to as “fiber noise band”. Also in a case where the waveguide 72 is an optical waveguide other than an optical fiber cable, similar noise can be generated due to a similar factor.

The width of the fiber noise band depends on the optical path length d₂ of the waveguide 72. To expand the measurable band by narrowing the fiber noise band, it is effective to shorten the optical path length d₂ of the waveguide 72. However, shortening the optical path length d₂ makes it difficult to separately place the optical head 200 and the LiDAR unit 100. In the present embodiment, as will be mentioned later, the optical path lengths d₁, d₂, d₄, and d₅ are set so that even in a case where the optical path length d₂ is lengthened to some degree, the measurable range can be widened with a reduction in the influence of the fiber noise.

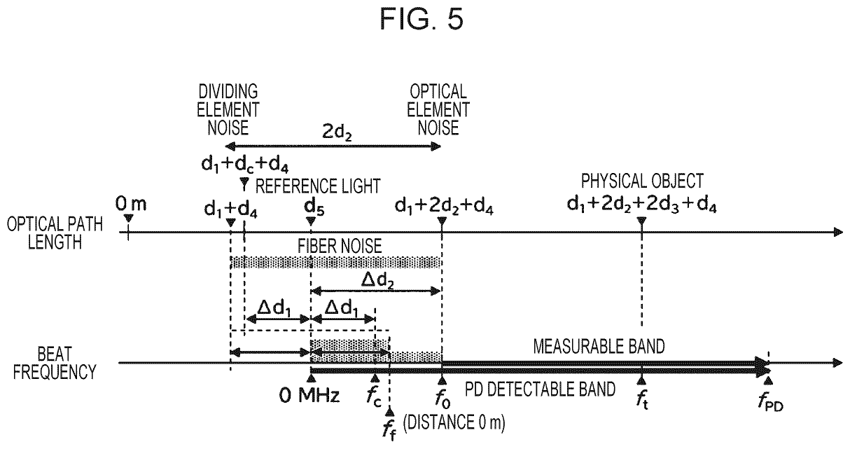

FIG. 5 is a diagram for explaining a relationship between optical path length and beat frequency and the influence of various types of noise in more detail. The optical path length here represents an optical path length starting at the splitter 32 and ending at the coupling element 36.

In the example shown in FIG. 5, the optical path length d₅ of the reference light is longer than the optical path length d₁+d_{c}+d₄ of the light that generates the dividing element noise and shorter than the optical path length d₁+2d₂+d₄ of light that generates the optical element noise. The dividing element noise is generated at a frequency f_{c} corresponding to the absolute value Δd₁ of the difference between d₁+d_{c}+d₄ and d₅. The optical element noise is generated at a frequency f₀ corresponding to the absolute value Δd₂ of the difference between d₁+2d₂+d₄ and d₅. The frequency f₀ corresponds to a zero-meter point of measurement of the distance. Assuming that f_{PD} is the maximum value of a frequency that is able to be detected by the photodetector 50, the measurable band ranges from f₀ to f_{PD}. Let it be assumed that fₜ is a beat frequency corresponding to the reflected light from the physical object 10.

The fiber noise is generated in a band of frequencies of 0 to f₀. This band is a fiber noise band. At a frequency f_{f} corresponding to a range of 0 to |d₁+d₄−d₅| in the fiber noise band, the fiber noise is doubly generated, so that the intensity of noise is approximately twice as high.

In the example shown in FIG. 5, d₅ is smaller than the average of d₁+d_{c}+d₄ and d₁+2d₂+d₄. For this reason, f_{c} is smaller than f₀. In this case, the dividing element noise does not affect the measurement of the distance. In a case where d₅ is smaller than the average of d₁+d_{c}+d₄ and d₁+2d₂+d₄ unlike in this example, f_{c} exceeds f₀, so that short-distance measurement, in particular, is affected. Setting the optical path lengths d₁, d₂, d₄, and d₅ so that Δd₁<Δd₂, i.e. |d₁+d_{c}+d₄−d₅|<|d₁+2d₂+d₄−d₅|, is satisfied makes it possible to reduce the effect of the dividing element noise on the measurement of the distance. In a case where d_{c} is sufficiently smaller than d₁ and d₄, the optical path lengths d₁, d₂, d₄, and d₅ may be set with an approximation d_{c}≈0 so that |d₁+d₄−d₅|<|d₁+2d₂+d₄−d₅| is satisfied.

The band of frequencies that are able to be detected with the photodetector 50, i.e. the PD detectable range, is the range of 0 to f_{PD}. Of the range, the range of f₀ to f_{PD} is a measurable band in which the distance to or the velocity of the physical object 10 can be measured. Lowering the frequency f₀ makes it possible to expand the measurable band. The frequency f₀ can be lowered by adjusting the optical path lengths d₁, d₂, d₄, and d₅. For example, the frequency f₀ can be lowered by bringing the optical path length d₅ of the reference light close to d₁+2d₂+d₄. However, simply bringing d₅ close to d₁+2d₂+d₄ causes the effect of the dividing element noise or the fiber noise to reach a frequency exceeding the frequency f₀ and can result, on the contrary, in a narrower measurable band.

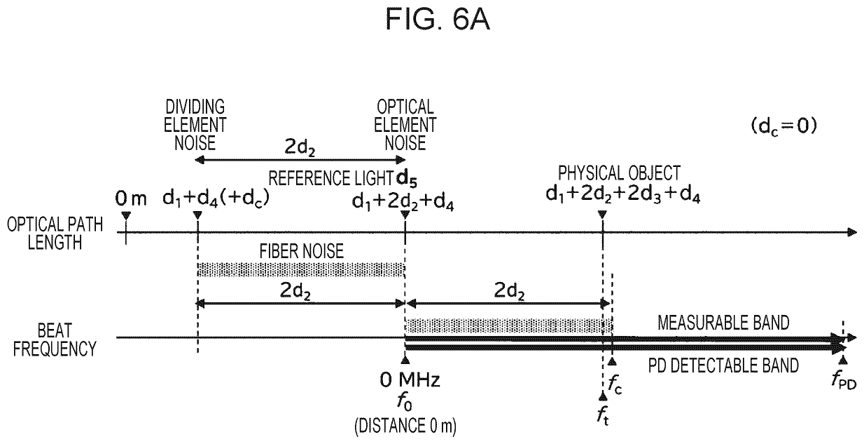

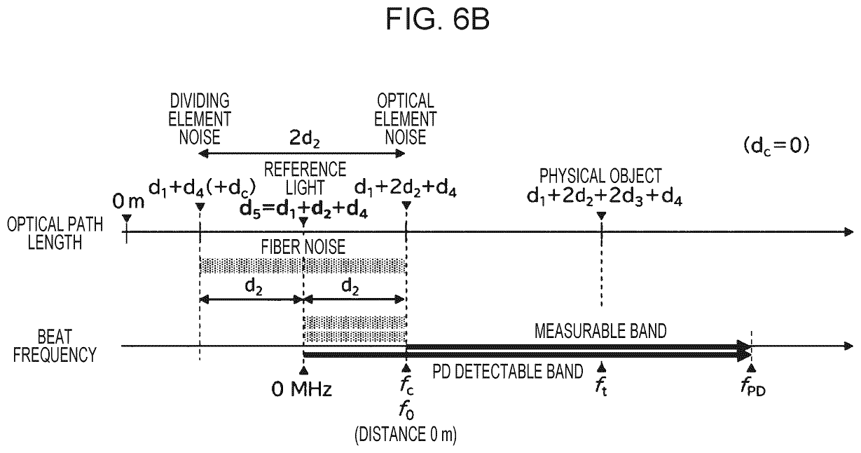

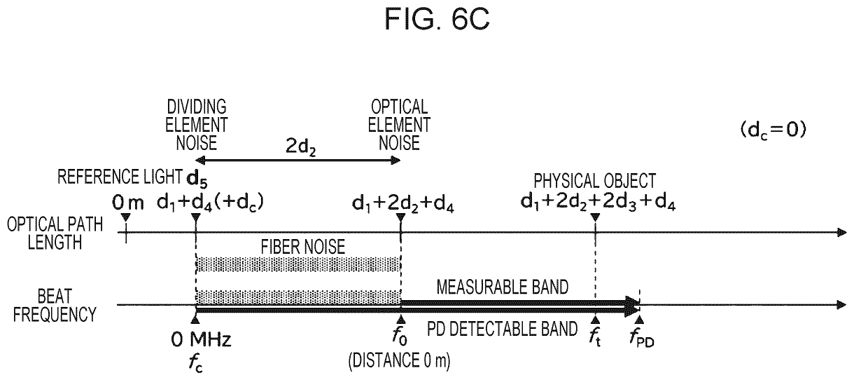

FIGS. 6A to 6C are diagrams showing examples of various frequencies with changes in the optical path length d₅ of the reference light. Let it be assumed for simplicity here that d_{c}=0. FIG. 6A shows an example of a case where d₅=d₁+2d₂+d₄. FIG. 6B shows an example of a case where d₅=d₁+d₂+d₄. FIG. 6C shows an example of a case where d₅=d₁+d₄.

As shown in FIG. 6A, in a case where the optical path length d₅ of the reference light matches the optical path length d₁+2d₂+d₄ of reflected light reflected off the optical element 40, the frequency f₀ corresponding to the optical element noise reaches its minimum of 0 MHz, and this frequency correspond to a distance of 0 m. For this reason, it seems that a range of distances in which distance measurement is possible (hereinafter also called “distance-measuring range”) can be widened most. However, in this case, the fiber noise and the dividing element noise are generated at the frequency f_{c} corresponding to the optical path length difference 2d₂, so that a physical object whose signal is weak cannot be detected in a band of frequencies of 0 to f_{c}. Accordingly, the actual distance-measuring range is narrowed down to a range of distances corresponding to a range of frequencies f_{c} to f_{PD}.

As shown in FIG. 6B, it is in a case where the optical path length d₅ of the reference light is made equal to d₁+d₂+d₄ that a maximum distance-measuring range is attained with the fiber noise taken into account. In this case, the fiber noise band is a band of frequencies of 0 to f_{c} corresponding to the optical path length d₂. In this example, the frequency f_{c} corresponding to the dividing element noise and the frequency f₀ corresponding to the optical element noise match each other, and neither fiber noise nor dividing element noise appears in a band of frequencies that are higher than the frequency. Since the fiber noise band can be reduced by a half as compared with the example shown in FIG. 6A, the measurable band, i.e. the distance-measuring range, can be expanded.

Meanwhile, as shown in FIG. 6C, in a case where the optical path length d₅ of the reference light is made equal to an optical path length d₁+d₄ corresponding to the dividing element noise, the fiber noise band is a band of frequencies of 0 to f₀ corresponding to the optical path length difference 2d₂ from 0 MHz. In this case, the optical element does not appear, but the fiber noise appears in the widest band as in the case of FIG. 6A. This results in a narrower distance-measuring range. In a case where the optical path length d₅ of the reference light is made shorter than d₁+d₄, the frequency f₀ corresponding to the optical element noise becomes even higher, and a band that does not contribute to measurement appears in a band that is lower than the fiber noise band, so that the measurable band becomes even narrower. Therefore, the optical path length d₅ of the reference light is set to a value that is higher than or equal to d₁+d₄.

In the present embodiment, as shown in FIG. 6C, the measurement apparatus 500A is designed to be able to measure the distance to and/or the velocity of the physical object 10 even in a case where the optical path length d₅ of the reference light matches d₁+d₄ and the fiber noise band appears in the widest band equivalent to the optical path length difference 2d₂. In the example shown in FIG. 6C, the upper-limit frequency f₀ of the fiber noise band is expressed by Formula (3) as follows:

$${f}_{0} = 2 {d}_{2} \times Δ f / c Δ t \qquad ( 3 )$$

In order to make it possible to measure the distance to the physical object 10, the measurement apparatus 500A is designed so that the fiber noise band falls within the PD detectable band. That is, the measurement apparatus 500A can be designed to satisfy Formula (4) as follows:

$${f}_{PD} > 2 {d}_{2} \times Δ f / c Δ t \qquad ( 4 )$$

In a case where the maximum value of a frequency that is able to be detected by a frequency analysis by the processing circuit 60 is lower than the maximum value of the frequency that is able to be detected by the photodetector 50, Formula (4) may be satisfied with the former frequency being f_{PD}.

Further, when D₁ is the measurable maximum value of the distance from the optical element 40 to the physical object 10, the measurement apparatus 500A is designed so that a target frequency corresponding to Dₜ falls within the PD detectable band. The target frequency is the sum of the frequency f₀, which depends on d₂, and the frequency shift amount, which depends on Dₜ. That is, the measurement apparatus 500A can be designed to satisfy Formula (5) as follows:

$${f}_{PD} > ( 2 {d}_{2} + 2 {D}_{t} ) \times Δ f / c Δ t \qquad ( 5 )$$

It is desirable that the fiber noise band be less than 50% of the PD detectable band, that is, the distance-measuring range be 50% or more. Accordingly, the measurement apparatus 500A can be designed to satisfy Formula (6) as follows:

$$\frac{2 {d}_{2} \times Δ f / c Δ t}{{f}_{PD}} < 0.5 \qquad ( 6 )$$

As one example, in a case where Δf=9.2 GHZ, Δt=10 microseconds (μs), f_{PD}=250 MHz, and the distance to a physical object at a distance of 20 meters (m) ahead is measured, a target frequency corresponding to the distance to the physical object is approximately 170 MHz, which is a frequency of 68% of 250 MHz. If Formula (6) above is satisfied, it is possible to measure the distance to such a physical object.

As can be seen from Formula (3), the fiber noise band can be reduced by decreasing Δf. Meanwhile, the resolution of distance measurement depends on Δf. For example, in a case where Δf is 9.2 GHz, the distance to a physical object at a distance of 1 meter (m) ahead can be measured with millimeter (mm) accuracy.

Since the fiber noise band depends on the optical path length d₂ of the waveguide 72 as noted above, bringing d₂ close to 0 makes it possible to reduce the effect of the fiber noise. However, bringing d₂ close to 0 can cause the optical element noise to have an effect.

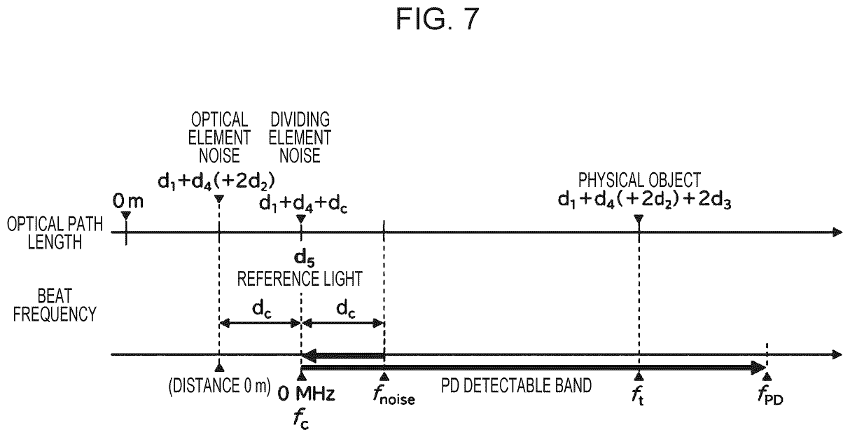

FIG. 7 is a diagram for explaining the influence of optical element noise in a case where the optical path length d₂ of the waveguide 72 is brought close to 0. In this example, the optical path length d_{c} of noise light inside the dividing element 34 is taken into account. The optical element noise is generated at a frequency corresponding to the absolute value of the difference between the optical path lengths d₁+d₄+2d₂ and d₅. In a case where d₂≈0, the optical element noise is generated at a frequency corresponding to the absolute value of the difference between the optical path lengths d₁+d₄ and d₅. Meanwhile, the dividing element noise is generated at a frequency corresponding to the absolute value of the difference between the optical path lengths d₁+d₄+d_{c} and d₅. In the example shown in FIG. 7, the optical path length d₅ of the reference light is equal to the optical path length d₁+d₄+d_{c} of the noise light that generates the dividing element noise. In this case, the optical element noise is generated at a frequency corresponding to the optical path length difference d_{c}. Further, since the point of distance 0 corresponds to the optical path length d₁+d₄ (+2d₂), which is shorter than the optical path length d₅ of the reference light, two different distances correspond to the same target frequency in a section of 2d_{c}. This makes it impossible to measure distance in this section. Such a problem can be avoided by designing the measurement apparatus 500A to satisfy Formula (7) as follows:

$$2 {d}_{2} \geq {d}_{c} \qquad ( 7 )$$

The dividing element 34 can be, for example, a circulator or a splitter. No matter whether the dividing element 34 is a circulator or a splitter, the various optical path lengths can be adjusted to satisfy Formula (7) in view of the optical path length d_{c} of noise light that directly propagates from the light source 20 toward the photodetector 50.

Furthermore, in a case where the optical path length d₅ of the reference light is different from d₁+d₄+d_{c}, the dividing element noise is generated. The distance-measuring range can be widened by adjusting the variety of optical path lengths so that spectroscopic element noise is generated at a lower frequency than is the dividing element noise. Therefore, the measurement apparatus 500A can be designed to satisfy Formulas (8) and (9) as follows:

$${d}_{5} \leq {d}_{1} + 2 {d}_{2} + {d}_{4} \qquad ( 8 )$$

$$\vert {d}_{1} + 2 {d}_{2} + {d}_{4} - {d}_{5} \vert \geq \vert {d}_{1} + {d}_{4} + {d}_{c} - {d}_{5} \vert \qquad ( 9 )$$

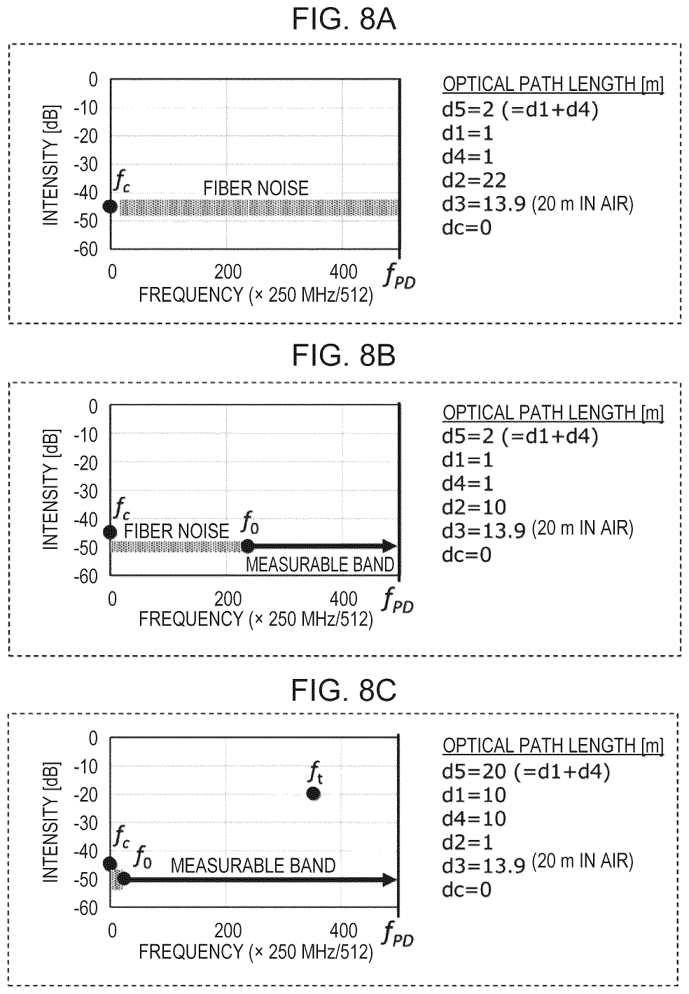

FIGS. 8A to 8C are diagrams showing examples of changes in the frequencies of various types of noise and the target frequency in a case where various optical path lengths are adjusted. In each of the examples, Δf=9.2 GHZ, Δt=10 microseconds (μs), and f_{PD}=250 MHz. The optical path lengths d₁, d₂, d₃, d₄, d₅, and d_{c} in each of the examples shown in FIGS. 8A to 8C are as shown on the right side of the graph.

In the example shown in FIG. 8A, the optical path length d₂ of the optical waveguide 72 is 22 m. In the example shown in FIG. 8B, the optical path length d₂ of the optical waveguide 72 is 10 m. In the example shown in FIG. 8C, the optical path length d₂ of the optical waveguide 72 is 1 m. In each of the examples, the optical path length d₅ of the waveguide 75 is equal to d₁+d₄. In the examples shown in FIGS. 8A and 8B, d₁=d₄=1 m, and d₅=2 m. In the example shown in FIG. 8C, d₁=d₄=10 m, and d₅=20 m. In each of the examples, the optical path length d_{c} is 0 m.

In the example shown in FIG. 8A in which d₂=22 m, Formula (4) above is not satisfied. For this reason, the fiber noise fills the entire PD detectable band, making it impossible to measure the distance and the velocity. To make a measurement, it is necessary to further shorten the optical path length d₂.

In the example shown in FIG. 8B in which d₂=10 m, Formulas (4), (6), (7), (8), and (9) are satisfied. In this case, the measurable band becomes 50% or more of the PD detectable band, so that it is possible to measure distance. However, since the frequency f₀ shown in Formula (3) is high and the measurable band is somewhat narrow, Formula (5) is not satisfied for a physical object at a distance of 20 m ahead, so that the distance cannot be measured.

On the other hand, in the example shown in FIG. 8C in which d₂=1 m, d₁=d₄=10 m, and d₅=20 m, the fiber noise band can be narrowed, as d₂ is short. This makes it possible to widen the measurable band. In this case, all of Formulas (4), (5), (6), (7), (8), and (9) are satisfied, so that it is possible to measure the distance to a physical object at a distance of 20 m ahead.

As shown in FIG. 5, according to the optical path length d₅ of the reference light, the fiber noise band can include a band in which the intensity of fiber noise is twice as high and a band in which the intensity of fiber noise is once as high. In a case where the strength of a beat signal attributed to reflected light from a physical object is more than once as high and lower than twice as high as the intensity of fiber noise, the distance-measuring range can be widened by also utilizing the band in which the intensity of fiber noise is once as high.

Although, in the present embodiment, the LiDAR unit 100 and the optical head 200 are separated from each other as shown in FIG. 1, they do not need to be separated from each other. For example, each constituent element of the LiDAR unit 100 and the optical element 40 may be accommodated in one housing. Even in that case, the measurable distance range can be expanded by setting each optical path length so that some or all of Formulas (4), (5), (6), (7), (8), and (9) above are satisfied.

### Modifications

The following describes modifications of the present embodiment.

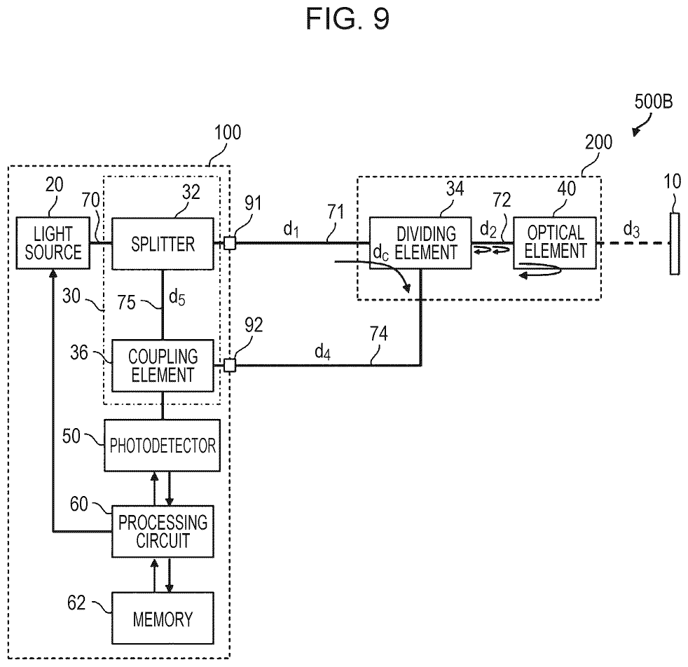

FIG. 9 is a block diagram showing a configuration of a measurement apparatus 500B according to a first modification. The measurement apparatus 500B according to the present modification differs from the measurement apparatus 500A shown in FIG. 1 in that the dividing element 34 is accommodated not in the LiDAR unit 100 but in the optical head 200.

In the case of a large physical object 10 or in the case of a physical object 10 having a complex structure, an optical head 200 including an optical element 40 (e.g. a beam shaper) needs to be placed at various positions or angles. Shortening the optical path length d₂ of the waveguide 72 in addition to satisfying the aforementioned Formulas (4), (5), (6), (7), (8), and (9) makes it possible to narrow the fiber noise band and expand the measurable distance range. For this reason, it is effective to bring the dividing element 34 close to the optical element 40. Accordingly, in the present modification, the dividing element 34 and the optical element 40 are accommodated in a housing of the optical head 200, and the waveguide 72 is shorter than that of the example shown in FIG. 1. Lengthening the waveguides 71 and 74 instead of lengthening the waveguide 72 makes it possible to flexibly change the position and orientation of the optical head 200.

In the present modification, the housing of the LiDAR unit 100 accommodates the light source 20, the interference optical system 30, the photodetector 50, the processing circuit 60, and the memory 62. The interference optical system 30 includes the splitter 32 and the coupling element 36. The LiDAR unit 100 includes an outputter 91 that outputs light from the splitter 32 to the waveguide 71 and an inputter 92 to which reflected light from the physical object 10 that has propagated through the waveguide 74 is inputted. The outputter 91 and the inputter 92 can be achieved, for example, by an optical output port and an optical input port, respectively, provided in the housing of the LiDAR unit 100. The waveguide 71 is connected to the outputter 91, and the waveguide 74 is connected to the inputter 92. The waveguides 71 and 74 can both be achieved by optical fiber cables. The waveguides 71 and 74 may be bundled in one cable. The LiDAR unit 100 may accommodate only some of the light source 20, the interference optical system 30, the photodetector 50, the processing circuit 60, and the memory 62. For example, the processing circuit 60 and the memory 62 may be provided in a device outside the LiDAR unit 100. Waveguides (e.g. the waveguides 70 and 75) in the LiDAR unit 100 may be optical fiber waveguides or may be formed on a chip. Such a chip may have at least one of the light source 20, the photodetector 50, the processing circuit 60, and the memory 62 integrated thereon.

The optical head 200 according to the present modification accommodates the dividing element 34, the optical element 40, the waveguide 72, part of the waveguide 71, and part of the waveguide 74. The LiDAR unit 100 and the optical head 200 are connected to each other by the waveguides 71 and 74. Since the optical path length d₁ of the waveguide 71 and the optical path length d₄ of the waveguide 74 have nothing to do with fiber noise, the optical path length d₁ of the waveguide 71 and the optical path length d₄ of the waveguide 74 can be lengthened by adjusting the optical path length d₅ of the waveguide 75. This makes it easy to expand the measurable distance range while reducing fiber noise by shortening the optical path length d₂ of the waveguide 72.

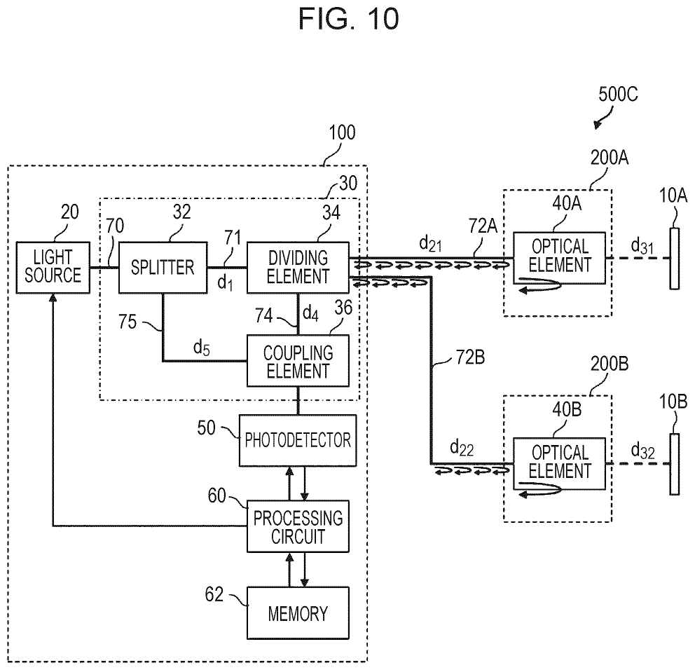

Although, in each of the example configurations shown in FIGS. 1 and 9, only one optical head 200 is provided, a plurality of optical heads may be provided. For example, as in the case of a measurement apparatus 500C shown in FIG. 10, two optical heads 200A and 200B may be provided. In the example shown in FIG. 10, the dividing element 34 and the first optical head 200A are connected to each other by a waveguide 72A, and the dividing element 34 and the second optical head 200B are connected to each other by a waveguide 72B. Causing the optical path length d₂₁ of the waveguide 72A and the optical path length d₂₂ of the waveguide 72B to be different lengths makes it possible to measure the distances to or the velocities of a plurality of physical objects 10A and 10B or a plurality of portions of one physical object. Let it be assumed here that d₃₁ is the distance from an optical element 40A of the first optical head 200A to the physical object 10A and that d₃₂ is the distance from an optical element 40B of the second optical head 200B to the physical object 10B. In this case, the measurable distance range can be expanded by determining each optical path length so that some or all of the aforementioned Formulas (4), (5), (6), (7), (8), and (9) are satisfied with the optical path length d₂₁ or d₂₂ being d₁ and d₃₁ or d₃₂ being d₃. Alternatively, three or more optical heads may be provided. Further, as in the case of the example shown in FIG. 9, each optical head may further include a dividing element 34.

In a case where a plurality of optical heads are provided, the dividing element 34 may be replaced by an optical router placed between the LiDAR unit and each optical head so that an optical head that performs the input and output of light can be selected. In a case where the dividing element 34 is a splitter, light intensity becomes ½ time as high when light is divided or coupled. This may be avoided by placing an optical router instead of the splitter so that one optical head can be selected from among the plurality of optical heads. This makes it possible to reduce optical losses at the time of dividing and coupling.

### Calibration Method

The following describes an example of a method for calibrating a measurement apparatus. An example of a method for calibrating the configuration shown in FIG. 9 is described here. A similar calibration method can also be applied to the configuration shown in FIG. 1.

First, the measurement apparatus 500B shown in FIG. 9 is constructed, and the physical object 10 is placed in a location away from the optical head 200. For example, the physical object 10 is placed in a location at a distance of 1 m from the optical head 200. As the physical object 10, a silver diffuser panel having a high reflectance to some degree or other objects can be used. The physical object 10 is placed so that reflected light from the physical object 10 returns to the optical element 40 (e.g. a collimator lens). The physical object 10 is irradiated with light, and on the basis of a beat signal detected by the photodetector 50, whether the frequency f₀ corresponding to the optical element noise matches the maximum value of the fiber noise band is checked. In a case where the frequency f₀ does not match the maximum value of the fiber noise band, the frequency f₀ is made equal to the maximum value of the fiber noise band by adjusting the optical path length d₅ of the reference light. Further, whether the fiber noise band has become a target band (e.g. less than 50% of the PD detectable band) is checked. In a case where the fiber noise band has not become the target band, the fiber noise band is set to the target band by adjusting the optical path lengths d₂ and d₅. This makes it possible to achieve a measurement apparatus that satisfies Formulas (4) to (9) above.

### CONCLUSION

The present disclosure is not limited to the aforementioned embodiments. Applications to each embodiment of various alterations conceived of by persons skilled in the art, applications to each modification of various alterations conceived of by persons skilled in the art, aspects constructed by combining constituent elements of different embodiments, aspects constructed by combining constituent elements of different modifications, aspects constructed by combining a constituent element of any embodiment and a constituent element of any modification may be encompassed in the present disclosure, as long as such applications and aspects do not depart from the scope of the present disclosure.

The foregoing description of embodiments discloses the following technologies.

### Technology 1

A measurement apparatus including:
a light source that emits light whose frequency varies with time;
a splitter that divides the light from the light source into irradiating light that is shone on a physical object and reference light;
a first waveguide through which the irradiating light from the splitter and reflected light reflected from the physical object pass together; and
a photodetector that detects interfering light generated by interference between the reflected light branched from the first waveguide and the reference light,
wherein

$${f}_{PD} > 2 {D}_{1} \times Δ f / c Δ t ,$$

where Δf is a change in the frequency during time Δt, c is the speed of light, D₁ is an optical path length of the first waveguide, and f_{PD} is a maximum value of a frequency that is able to be detected by the photodetector.

### Technology 2

The measurement apparatus according to technology 1, wherein the photodetector outputs a signal corresponding to an intensity of the interfering light,
the measurement apparatus further including a processing circuit that computes a distance to the physical object and/or a velocity of the physical object on the basis of the signal outputted from the photodetector.

### Technology 3

The measurement apparatus according to technology 1 or 2, further comprising an optical element that irradiates the physical object with the irradiating light having passed through the first waveguide and introduces the reflected light into the first waveguide,

wherein

$${f}_{PD} > ( 2 {D}_{1} + 2 {D}_{t} ) \times Δ f / c Δ t ,$$

where Dₜ is a measurable maximum value of a distance from the optical element to the physical object.

### Technology 4

The measurement apparatus according to any of technologies 1 to 3, wherein

$$\frac{2 {D}_{1} \times Δ f / c Δ t}{{f}_{PD}} < 0.5 .$$

### Technology 5

The measurement apparatus according to any of technologies 1 to 4, further including:
a second waveguide that branches off from the first waveguide and that allows passage of the reflected light having passed through the first waveguide;
a third waveguide through which the irradiating light from the splitter passes; and
a dividing element that inputs, to the first waveguide, the irradiating light having passed through the third waveguide and that inputs, to the second waveguide, the reflected light having passed through the first waveguide,
wherein

$$2 {D}_{1} \geq {d}_{c} ,$$

where d_{c} is an optical path length in the dividing element along which a portion of the irradiating light from the third waveguide travels through the dividing element toward the second waveguide.

### Technology 6

The measurement apparatus according to technology 5, further including:
a fourth waveguide through which the reference light from the splitter passes; and
a coupling element that inputs, to the photodetector, interfering light generated by interference between the reference light having passed through the fourth waveguide and the reflected light having passed through the second waveguide,
wherein

$${D}_{4} \leq {D}_{3} + 2 {D}_{1} + {D}_{2} , and \\ \vert {D}_{3} + 2 {D}_{1} + {D}_{2} - {D}_{4} \vert \geq \vert {D}_{3} + {D}_{c} + {D}_{2} - {D}_{4} \vert ,$$

where D₂ is an optical path length of the second waveguide, D₃ is an optical path length of the third waveguide, and D₄ is an optical path length of the fourth waveguide.

### Technology 7

The measurement apparatus according to any of technologies 1 to 6, further including an optical head that accommodates at least part of the first waveguide and at least part of a third waveguide that inputs the irradiating light from the splitter to the first waveguide.

### Technology 8

A measurement apparatus including:
a LiDAR unit including a light source, a splitter that divides light from the light source into irradiating light and reference light, an outputter that outputs the irradiating light from the splitter, an inputter to which reflected light from a physical object irradiated with the irradiating light is inputted, and a photodetector that detects the reflected light and the reference light;
a first waveguide through which the irradiating light and the reflected light pass together;
a second waveguide that branches off from the first waveguide and that inputs, to the inputter, the reflected light having passed through the first waveguide; and
a third waveguide that inputs, to the first waveguide, the irradiating light outputted from the outputter.

### Technology 9

The measurement apparatus according to technology 8, wherein the LiDAR unit further includes a fourth waveguide through which the reference light from the splitter passes and a coupling element that inputs, to the photodetector, interfering light generated by interference between the reference light having passed through the fourth waveguide and the reflected light having passed through the second waveguide.

### Technology 10

The measurement apparatus according to technology 9, further including a chip having the light source, the splitter, the coupling element, and the photodetector integrated thereon,
wherein
the outputter is an element that couples together a waveguide on the chip connected to the splitter and the third waveguide, and
the inputter is an element that couples together another waveguide on the chip connected to the coupling element and the second waveguide.

### Technology 11

The measurement apparatus according to technology 10, wherein the chip further has integrated thereon a processing circuit that computes a distance to the physical object and/or a velocity of the physical object on the basis of a signal outputted from the photodetector.

### Technology 12

The measurement apparatus according to technology 9, further including a housing that accommodates the light source, the splitter, the coupling element, and the photodetector,
wherein
the outputter is an output terminal of the housing connected to the splitter, and
the inputter is an input terminal of the housing connected to the coupling element.

### Technology 13

The measurement apparatus according to technology 12, wherein the housing further includes a processing circuit that computes a distance to the physical object and/or a velocity of the physical object on the basis of a signal outputted from the photodetector.

### Technology 14

The measurement apparatus according to any of technologies 8 to 13, further including an optical head that accommodates at least part of the first waveguide, at least part of the second waveguide, and at least part of the third waveguide.

A measurement apparatus according to an embodiment of the present disclosure can be utilized for uses, for example, in a distance-measuring system that is mounted in a vehicle such as an automobile, an unmanned aerial vehicle (UAV), or an automated guided vehicle (AGV) or in vehicle detection.

What is claimed is:

1. A measurement apparatus comprising:
a light source that emits light whose frequency varies with time;
a splitter that divides the light from the light source into irradiating light that is shone on a physical object and reference light;
a first waveguide through which the irradiating light from the splitter and reflected light reflected from the physical object pass together; and
a photodetector that detects interfering light generated by interference between the reflected light branched from the first waveguide and the reference light,
wherein
$${f}_{PD} > 2 {D}_{1} \times Δ f / c Δ t ,$$
where Δf is a change in the frequency during time Δt, c is the speed of light, D₁ is an optical path length of the first waveguide, and f_{PD} is a maximum value of a frequency that is able to be detected by the photodetector.

2. The measurement apparatus according to claim 1, wherein the photodetector outputs a signal corresponding to an intensity of the interfering light,
the measurement apparatus further comprising a processing circuit that computes a distance to the physical object and/or a velocity of the physical object on the basis of the signal outputted from the photodetector.

3. The measurement apparatus according to claim 1, further comprising an optical element that irradiates the physical object with the irradiating light having passed through the first waveguide and that introduces the reflected light into the first waveguide,
wherein
$${f}_{PD} > ( 2 {D}_{1} + 2 {D}_{t} ) \times Δ f / c Δ t ,$$
where Dₜ is a measurable maximum value of a distance from the optical element to the physical object.

4. The measurement apparatus according to claim 1, wherein
$$\frac{2 {D}_{1} \times Δ f / c Δ t}{{f}_{PD}} < 0.5 .$$

5. The measurement apparatus according to claim 1, further comprising:
a second waveguide that branches off from the first waveguide and that allows passage of the reflected light having passed through the first waveguide;
a third waveguide through which the irradiating light from the splitter passes; and
a dividing element that inputs, to the first waveguide, the irradiating light having passed through the third waveguide and that inputs, to the second waveguide, the reflected light having passed through the first waveguide,
wherein
$$2 {D}_{1} \geq {d}_{c} ,$$
where d_{c} is an optical path length in the dividing element along which a portion of the irradiating light from the third waveguide travels through the dividing element toward the second waveguide.

6. The measurement apparatus according to claim 5, further comprising:
a fourth waveguide through which the reference light from the splitter passes; and
a coupling element that inputs, to the photodetector, interfering light generated by interference between the reference light having passed through the fourth waveguide and the reflected light having passed through the second waveguide,
wherein
$${D}_{4} \leq {D}_{3} + 2 {D}_{1} + {D}_{2} , and \\ \vert {D}_{3} + 2 {D}_{1} + {D}_{2} - {D}_{4} \vert \geq \vert {D}_{3} + {D}_{c} + {D}_{2} - {D}_{4} \vert ,$$
where D₂ is an optical path length of the second waveguide, D₃ is an optical path length of the third waveguide, and D₄ is an optical path length of the fourth waveguide.

7. The measurement apparatus according to claim 1, further comprising an optical head that accommodates at least part of the first waveguide and at least part of a third waveguide that inputs the irradiating light from the splitter to the first waveguide.

8. A measurement apparatus comprising:
a LiDAR sensor including a light source, a splitter that divides light from the light source into irradiating light and reference light, an outputter that outputs the irradiating light from the splitter, an inputter to which reflected light from a physical object irradiated with the irradiating light is inputted, and a photodetector that detects the reflected light and the reference light;
a first waveguide through which the irradiating light and the reflected light pass together;
a second waveguide that branches off from the first waveguide and that inputs, to the inputter, the reflected light having passed through the first waveguide; and
a third waveguide that inputs, to the first waveguide, the irradiating light outputted from the outputter.

9. The measurement apparatus according to claim 8, wherein the LiDAR sensor further includes:
a fourth waveguide through which the reference light from the splitter passes; and
a coupling element that inputs, to the photodetector, interfering light generated by interference between the reference light having passed through the fourth waveguide and the reflected light having passed through the second waveguide.

10. The measurement apparatus according to claim 9, further comprising a chip having the light source, the splitter, the coupling element, and the photodetector integrated thereon,
wherein
the outputter is an element that couples together a waveguide on the chip connected to the splitter and the third waveguide, and
the inputter is an element that couples together another waveguide on the chip connected to the coupling element and the second waveguide.

11. The measurement apparatus according to claim 10, wherein the chip further has integrated thereon a processing circuit that computes a distance to the physical object and/or a velocity of the physical object on the basis of a signal outputted from the photodetector.

12. The measurement apparatus according to claim 9, further comprising a housing that accommodates the light source, the splitter, the coupling element, and the photodetector,
wherein
the outputter is an output terminal of the housing connected to the splitter, and
the inputter is an input terminal of the housing connected to the coupling element.

13. The measurement apparatus according to claim 12, wherein the housing further includes a processing circuit that computes a distance to the physical object and/or a velocity of the physical object on the basis of a signal outputted from the photodetector.

14. The measurement apparatus according to claim 8, further comprising an optical head that accommodates at least part of the first waveguide, at least part of the second waveguide, and at least part of the third waveguide.
